(19) United States
(12) Patent Application Publication
(10) Pub. No.: US 2009/0150124 A1
(43) Pub. Date: Jun. 11, 2009

(54) MODEL BASED WORKFLOW FOR INTERPRETING DEEP-READING ELECTROMAGNETIC DATA

(75) Inventors: Michael Wilt, Abu Dhabi (AE); Herve Denaclara, Bourg-Madame (FR); Ping Zhang, Albany, CA (US); David Alumbaugh, Berkeley, CA (US); Thor Johnsen, Pleasanton, CA (US)

Correspondence Address: Schlumberger Technology Corporation, P. O. Box 425045, Cambridge, MA, 02142, US

(73) Assignee: SCHLUMBERGER TECHNOLOGY CORPORATION, Cambridge, MA (US)

(21) Appl. No.: 11/952,654

(22) Filed: Dec. 7, 2007

(51) Int. Cl. G06F 17/50; G06G 7/50

(52) U.S. Cl. 703/1; 703/10

(57) ABSTRACT

One embodiment of the invention involves a method for determining whether an electromagnetic survey will be able to distinguish between different subsurface conditions in an area that includes developing a three-dimensional electromagnetic property model of the area, and simulating an electromagnetic response of a field electromagnetic data acquisition system using the three-dimensional electromagnetic property model to determine if expected differences in an electromagnetic response of a electromagnetic data acquisition system are within detectability limits of the system. Another embodiment involves a model-based method of inverting electromagnetic data associated with a subsurface area that includes developing a three-dimensional electromagnetic property model of the area, and restricting changes that may be made to the model during the electromagnetic data inversion process. Other related embodiments of the inventive method are also described and claimed.

### FIELD OF THE INVENTION

This invention is generally related to the planning, acquisition, processing, and interpretation of geophysical data, and more particularly to a workflow for interpreting deep-reading electromagnetic data acquired during a field survey of a subsurface area and a related workflow associated with the planning and design of such a field survey.

### BACKGROUND

Deep-reading electromagnetic field surveys of subsurface areas typically involve large scale measurements from the surface, from surface-to-borehole, and/or between boreholes. Field electromagnetic data sense the reservoir and surrounding media in a large scale sense. At present, deep electromagnetic field surveys are typically conducted and interpreted in a piecemeal fashion. Surveys are often planned, conducted, and interpreted separately, often by different people, and models of the subsurface area under investigation are typically not generated until relatively late in the process, when the data are interpreted.

In this patent application, a new type of electromagnetic data interpretation workflow is described that first accumulates existing geophysical, geological, and petrophysical knowledge into a common model and then can base electromagnetic data simulation, processing, and interpretation on this model, as the underlying model is being updated and refined. By doing this, the method is able to take advantage of existing knowledge of the area, the reservoir, and the measurement scale of electromagnetic data acquisition technology to integrate model building and refinement into various aspects of the process.

Building blocks for the inventive process exist in a variety of different software and hardware products. In particular, model building software, simulation software, and upscaling processes are referred to below. The model building software typically used in the inventive method is called Petrel®, a general purpose geophysical data modeling package available from Schlumberger. This software package accepts a wide variety of input data, has sophisticated petrophysical and display options and is able to use geostatistics routines (i.e. interpolation and extrapolation routines, such as kriging) to populate a three dimensional grid in places where direct measurement data doesn't exist. Also referred to below are fluid flow simulation processes. Various software packages may be utilized for history matching purposes and to create a predictive model for multiphase fluid flow behavior in a reservoir. One commonly used simulator is called Eclipse®. This software package is also available from Schlumberger. Crosswell electromagnetic technology and surface-to-borehole electromagnetic technology refer to systems of the general type developed by Schlumberger and other companies for acquiring, processing, and interpreting deep formation imaging electromagnetic data. Upscaling refers to a set of processes that may be used to turn fine-scale data into coarser-scale data more suitable for modeling and simulation on a larger scale.

The benefits of various embodiments of the present inventive approach are many. First, this approach can provide a unifying framework for feasibility studies, survey design, data collection, and data interpretation activities for an electromagnetic data acquisition and processing project in a certain area. Secondly, this approach can reduce model uncertainty by using other types of data to appropriately constrain the model. Finally, this approach provides a common mechanism for integrating data of various types from an area so they can be easily compared and used together when appropriate.

The inventive method unifies the workflow of planning, acquiring, processing, and interpreting deep electromagnetic measurements through the one aspect they all have in common, the reservoir. The present method is able to utilize, for instance, geologic and flow models derived from wireline logging and/or logging-while-drilling data, seismic data including structural models derived from seismic data, and flow simulator results as a basis for survey design, simulation, data processing, and interpretation of deep electromagnetic surveys. The entire electromagnetic survey process may be guided by these models. They can be used to simulate the data acquisition process, direct survey design, process the data, and provide a basis for interpretation. The models can also be used in time lapse surveys through history matching of flow simulator results.

### SUMMARY OF INVENTION

One embodiment of the invention involves a method for determining whether an electromagnetic survey will be able to distinguish between different subsurface conditions in an area that includes developing a three-dimensional electromagnetic property model of the area and simulating an electromagnetic response of a field electromagnetic data acquisition system using the three-dimensional electromagnetic property model to determine if expected differences in an electromagnetic response of a electromagnetic data acquisition system are within detectability limits of the system. Another embodiment involves a model-based method of inverting electromagnetic data associated with a subsurface area that includes developing a three-dimensional electromagnetic property model of the area, and restricting changes that may be made to the model during the electromagnetic data inversion process. A further embodiment involves a method for determining the position of a borehole within a subsurface area that includes developing a three-dimensional electromagnetic property model of the area and allowing only borehole position to vary as electromagnetic data acquired from the subsurface area is inverted. Another embodiment involves a model-based method of processing electromagnetic data associated with a subsurface area that includes developing a three-dimensional electromagnetic property model of the area, extracting a two-dimensional section from the three-dimensional electromagnetic property model, inverting the electromagnetic data, thereby updating the two-dimensional section; and updating the three-dimensional electromagnetic property model by interpolating the updated two-dimensional section into the model. A further embodiment involves a model-based method for designing an electromagnetic survey that includes developing a three-dimensional electromagnetic property model of the area, extracting a two-dimensional section from the three-dimensional electromagnetic property model, and using the two-dimensional section during the design of the electromagnetic survey.

### BRIEF DESCRIPTION OF FIGURES

FIG. 1 is a flowchart illustrating various processes associated with alternative embodiments of the inventive method.

FIG. 2 is perspective view of an example Petrel background model assembled from logs and deviations surveys.

FIG. 3 displays simulation results of a base case and a water flooded interval.

FIG. 4 displays amplitude and phase results from base case and water flooded interval (scenario) simulations and the differences between these results.

FIG. 5 shows a starting model interwell resistivity section, a final model interwell resistivity section, and a section that displays the ratio of the resistivities between the starting model and final model sections.

### DETAILED DESCRIPTION

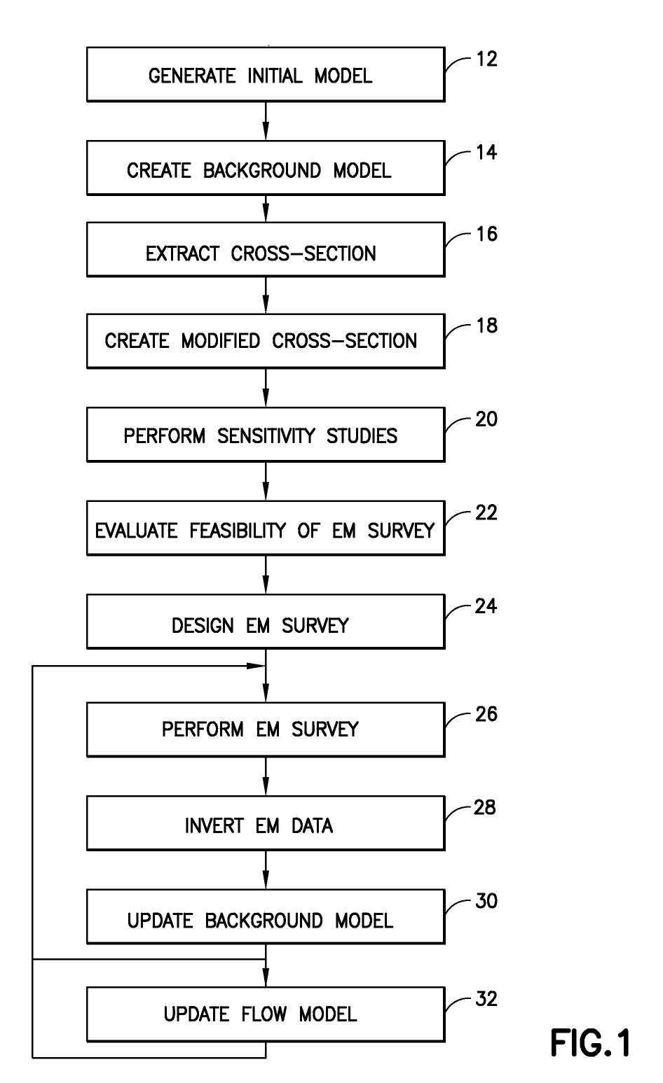

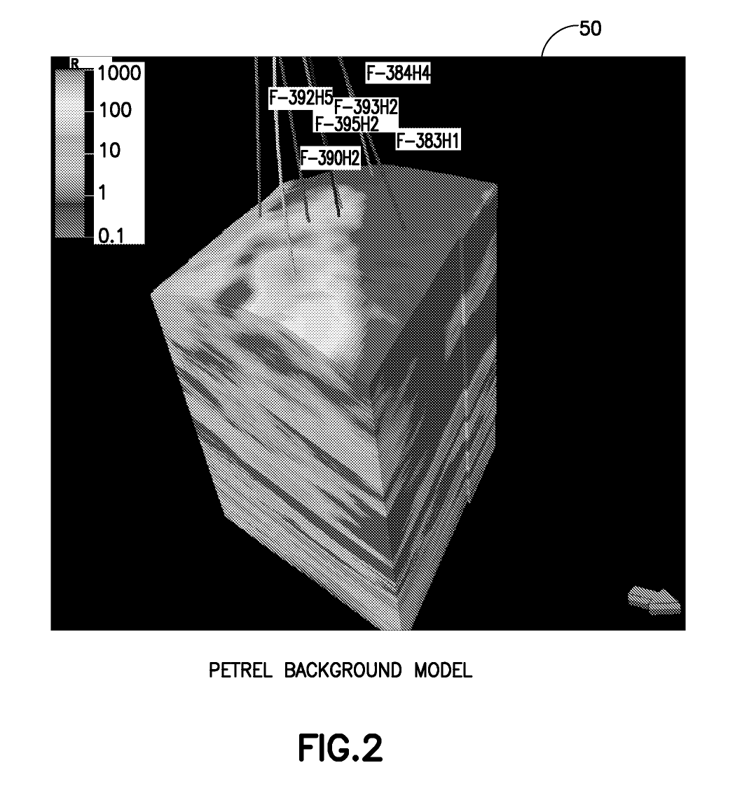

FIG. 1 is a flowchart that illustrates various processes associated with alternative embodiments of the inventive workflow. In Generate Initial Model 12, an initial model of the subsurface area under consideration may be developed, such as by using flow simulator results to roughly determine the characteristics of a water or steam flood of a hydrocarbon reservoir. The results of this initial model may be exported to Petrel along with other geological, seismic, or log data to construct a three dimensional background model of the subsurface area under consideration. This is shown in FIG. 1 as Create Background Model 14. The development and use of this type of background model is a unifying feature of the entire inventive process. An external perspective view of such a three dimensional Petrel background model is shown in FIG. 2.

A possible next process in the inventive workflow is to determine whether expected differences in the electromagnetic response of a field electromagnetic data acquisition system are within detectability limits of the system. This can be done using a two-dimensional procedure, for instance, by extracting a cross-section from the original background model to serve as an initial model for geophysical simulation. In this way, the background model is used to establish a base model for electromagnetic data sensitivity studies. This is shown in FIG. 1 as Extract Cross-Section 16.

This can then be followed by the creation of a modified two-dimensional section that corresponds to a different subsurface condition. This is shown in FIG. 1 as Create Modified Cross-Section 18. Two alternatives for creating the modified cross-section may be used. The cross-section extracted in Extract Cross-Section 16 may be modified or altered to create one or more alternative geophysical scenarios or alternatively, the background model may be modified to correspond to one or more different subsurface conditions and the modified cross-section may be extracted from this modified background model. This procedure could comprise, for instance, replacing hydrocarbons fluid in a particular reservoir interval with injected water in either the extracted cross-section or the background model. Alternatively, these processes could be performed using a related type of three-dimensional procedure where the simulated electromagnetic response is derived using software that can calculate simulated electromagnetic responses directly from original and modified three-dimensional electromagnetic property models.

Sensitivity studies of the type described in commonly-assigned U.S. patent application Ser. No. 11/836,978, filed Aug. 10, 2007 and entitled “Removing Effects of Near Surface Geology from Surface-To-Borehole Electromagnetic Data” (incorporated herein by reference) may be used to test the feasibility of different electromagnetic data acquisition configurations and serve as a basis for survey design. This process is shown in FIG. 1 as Perform Sensitivity Studies 20.

These sensitivity studies may be used to evaluate whether an electromagnetic survey will be able to distinguish between the base condition and the alternative scenario(s). This is shown in FIG. 1 as Evaluate Feasibility of EM Survey 22. These sensitivity studies can also be used to design the EM survey layout and data acquisition protocol. This is shown in FIG. 1 as Design EM Survey 24.

The next step in this embodiment of the inventive method is to make the electromagnetic field measurements, i.e. to acquire electromagnetic data probing the subsurface area of interest. This is shown in FIG. 1 as Perform EM Survey 26.

When the survey is complete, the electromagnetic data are used in an inverse process to adjust and update the model. This is shown in FIG. 1 as Invert EM Data 28 and Update Background Model 30. The model can be used to constrain the inversion so that the inversion does not venture into areas where changes are geologically unreasonable. The results can then be re-exported back into Petrel and if a flow simulator is involved the results may be re-exported into Eclipse, shown in FIG. 1 as Update Flow Model 32. The unique concept here is that the model is an integral part of the entire process and does not simply appear at the end. It may be developed, updated, and interpreted continuously throughout this process. These processes may be repeated to create time lapse images or analyses of the area under investigation.

The inventive method can unify the process of simulation, survey design, data collection and data interpretation of deep electromagnetic surveys through a common model. This model is assembled through the existing data base of logs, geophysical surveys and simulation results.

The benefits of various embodiment of this process are that they can: 1) Provide a common reference for the collection of geologic data, 2) Provide realistic constraints in interpretation through the inversion, 3) Provide a link between time lapse measurements and a flow model, 4) Provide realistic survey simulation, and 5) Provide more useful survey design based on present well field knowledge. Additional details regarding how such a model is assembled and how it can be used in data simulation, collection, and interpretation processes are provided below.

One type of electromagnetic data acquisition technique that may be used with the inventive methodology, crosswell electromagnetics, is a tomographic technology whereby the interwell resistivity distribution is determined from EM signals propagated between boreholes. The technology works by measuring the attenuation and phase rotation caused by the resistivity of the interwell formation and using this information to reconstruct the resistivity distribution between the wells.

The equipment used in this technique consists of standard wireline deployment of specialized sources and sensors. The source typically consists of an inductive frequency (1 Hz-10 kHz) solenoid (magnetic dipole) electromagnetic transmitter. This is typically a very powerful device where several amps of current are injected through many wire turns around a magnetically permeable core. In an offset well, a string of sensitive magnetic field detectors are deployed. The systems are synchronized such that the supplied field can be distinguished from the secondary field induced in the formation. A survey consists of mutual coupling measurements using multiple source and receiver position above, within, and below the depths of interest.

Interpretation is based on numerical model inversion of collected data to re-construct a two dimensional or three dimensional model. Field data are usually fit to a two dimensional model within the measurement error tolerance and a number of model constraints are employed to manage model non-uniqueness.

In surface-to-borehole EM, surface-based sources are used in concert with borehole receivers in the imaging. These sources can either be magnetic dipole antennas (like cross-borehole systems) or grounded wires. Surface antennas are typically moved along a particular azimuth to construct a two dimensional cross-section with the borehole. The remainder of the process is very similar to the cross-borehole workflow. Other embodiments where the inventive workflow can be used include borehole-to-surface EM and surface-based EM.

The new model is then typically altered from the original starting model using the surface-to-borehole survey results. Near-surface model parameters are typically not allowed to vary during the inversion. In this manner, the inversion is restricted to models where the formation resistivity is changing on the reservoir region, thereby providing a more meaningful solution.

The proposed workflow normally proceeds in particular stages that correspond to the maturity of the project. These are discussed in detail below.

### Concept Stage:

When crosswell or surface-to-borehole EM is considered for an application, the process often begins at a filtering stage. Here we typically use simple tool-planner software where a concept can be tested against the capabilities of the system. At this stage, the model is usually a simplified homogeneous or layered background, or perhaps an Eclipse result, and the simulation software is typically a simple ID model package to test tool viability for this application. The object at this stage is normally to remove unsuitable applications of the technology but the subsurface model building process often begins here.

### Model Assembly:

If the project passes the concept stage, the next step is assembling a background model. Here we prefer to collect all relevant logs, well deviations, geological and petrophysical results and subsurface geophysical results from an area surrounding the EM survey area. This data is imported into a geological data base program such as Petrel. The program then applies geostatistics and other techniques to fill a three dimensional cube of physical properties as defined by the petrophysical model.

In our case, the model is typically constructed from Rt, the formation resistivity parameter. This parameter is derived from logs, corrected for invasion effects and usually scaled up to match the cell size sampled by the EM survey.

An example of such a model is shown in FIG. 2 as Petrel Background Model 50. Here we see a cube of data encompassing the area of interest. We typically collect data within 7 interwell radii of the wells to be used in a crosswell study.

### Simulation:

Next, a two dimensional section is typically extracted from this cube. This is done using the well deviations and the resistivity grid existing in the data base. This two dimensional model may be the basis for simulation studies, where we alter either the base model or the two dimensional section to correspond to different scenarios to be investigated by the crosswell EM survey.

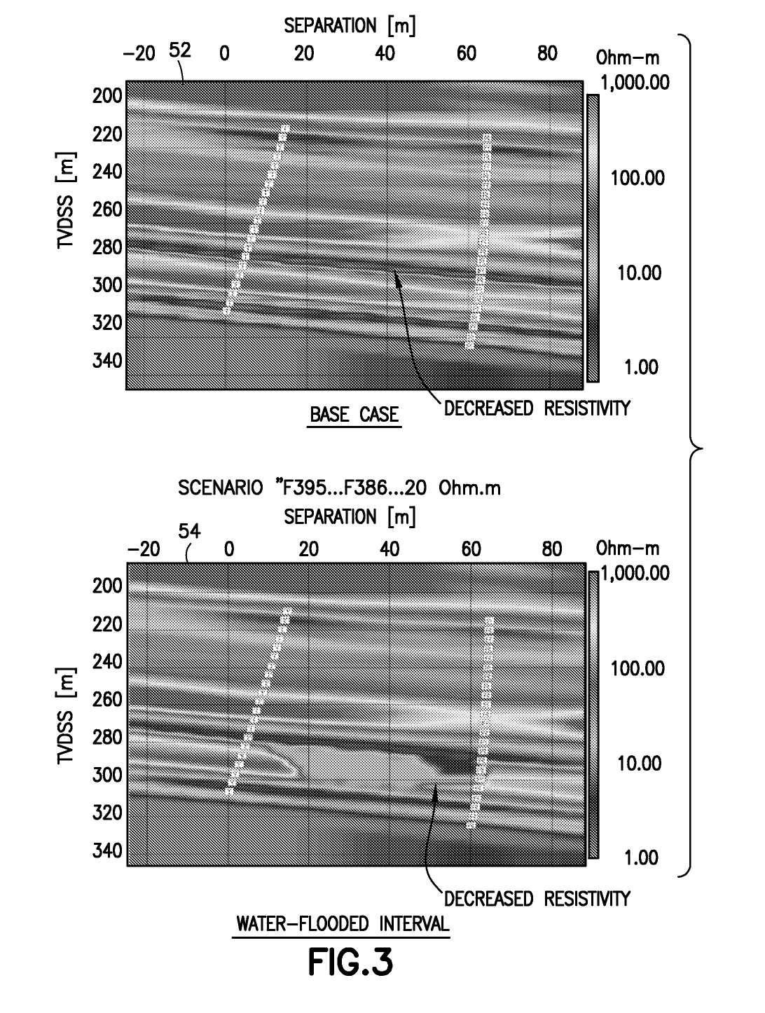

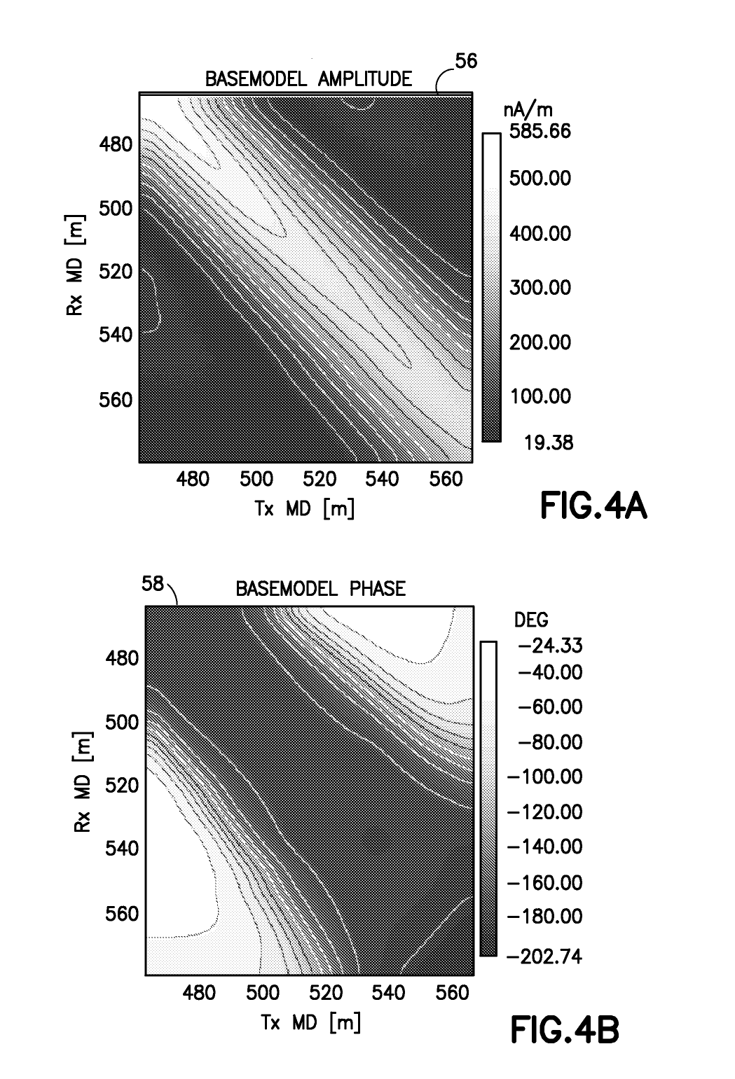

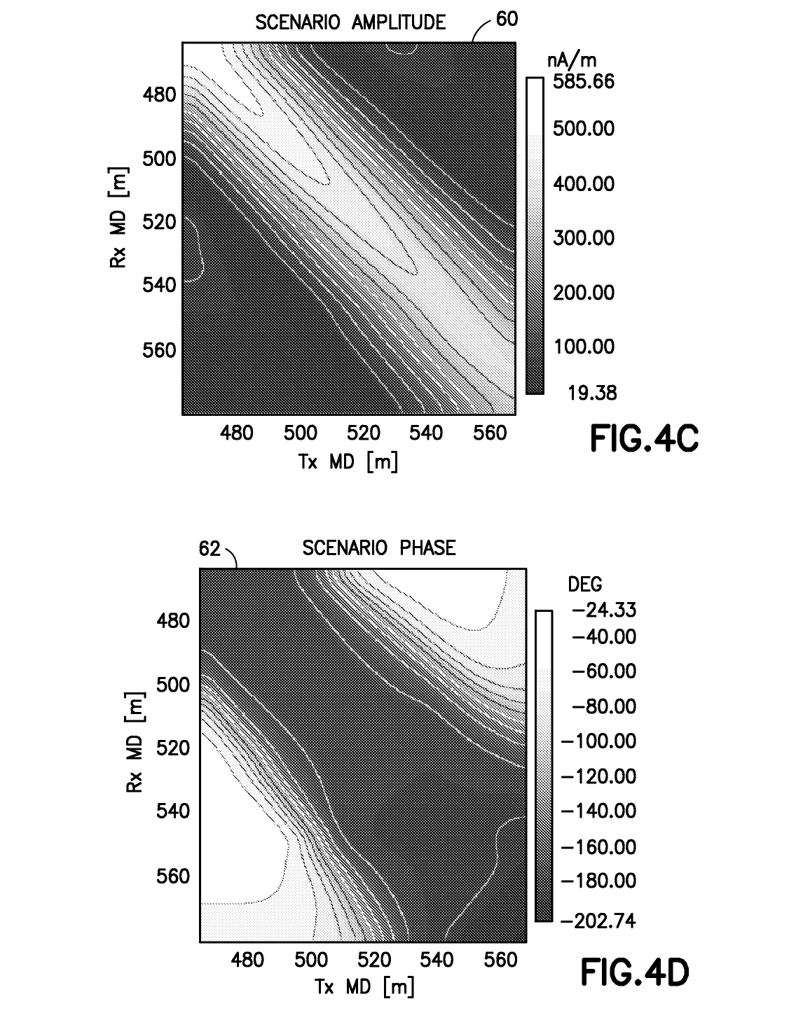

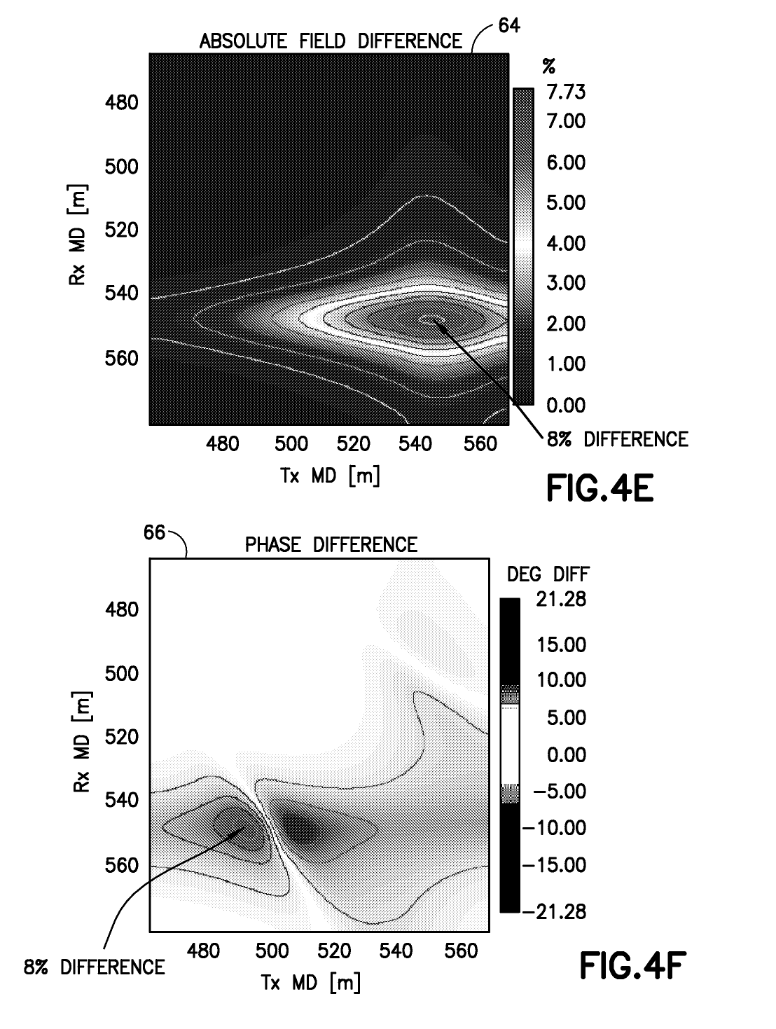

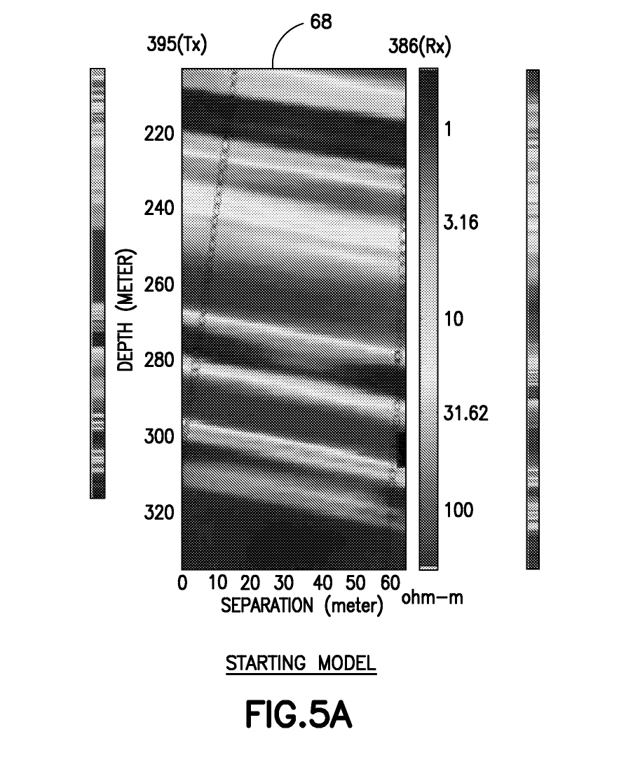

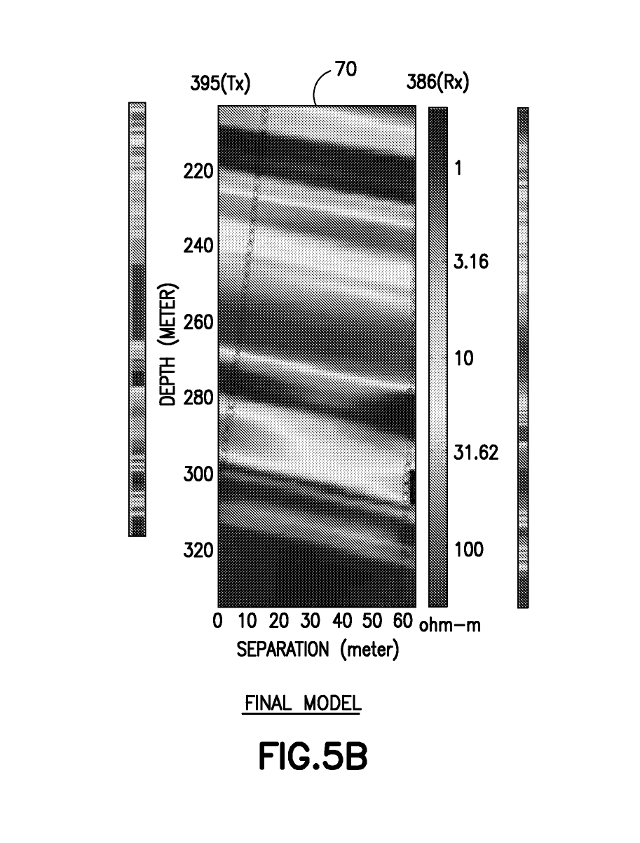

A typical example is shown in FIGS. 3 and 4. Here we have altered the extracted two-dimensional section to correspond to a case where water was injected between boreholes. An EM simulator is run on the two dimensional sections with and without the injected water present and the results determine if the target response is within the detectability limit of the field system. FIG. 3 displays simulation results of a Base Case 52 and a Water-Flooded Interval 54. FIG. 4 displays amplitude and phase results from base case and water flooded interval simulations and the difference between these results. As can be seen, Absolute Field Difference 64 displays the difference in amplitude between Basemodel Amplitude 56 and Scenario Amplitude 60 and Phase Difference 66 displays the difference in phase between Basemodel Phase 58 and Scenario Phase 62.

### Survey Design and Data Collection:

We next use the model in survey design. Here we select the frequency, the source and receiver spacings in the two wells, the amount of data required and thereby the logging speed, and finally calculate the quality control indicator requirements and the survey duration. This process is typically done using the same model described above. The EM survey is then undertaken and the EM data is acquired.

### Data Interpretation and Model Updating:

After data collection is complete, the model is used to guide the data inversion process. Inversion of EM data is notoriously nonunique. That is a variety of models can usually be fit to the same set of data within the error thresholds. The background model becomes critically important at this stage to decide which one of these alternative models is appropriate.

During the inversion, the model can be used to provide constraints on the resistivity of certain intervals, can be used to fix certain intervals from any change, and can provide sharp boundaries in formations that would not be discernable solely from the EM data.

Examples of such constraints are positivity conditions where the resistivity is allowed only to decrease in some intervals say to constrain water injection. Another case is a sharp boundary that is fixed by associating it with a good seismic reflection. This would likely be interpreted as a smooth boundary if the EM inversion was performed solely on the basis of the EM data.

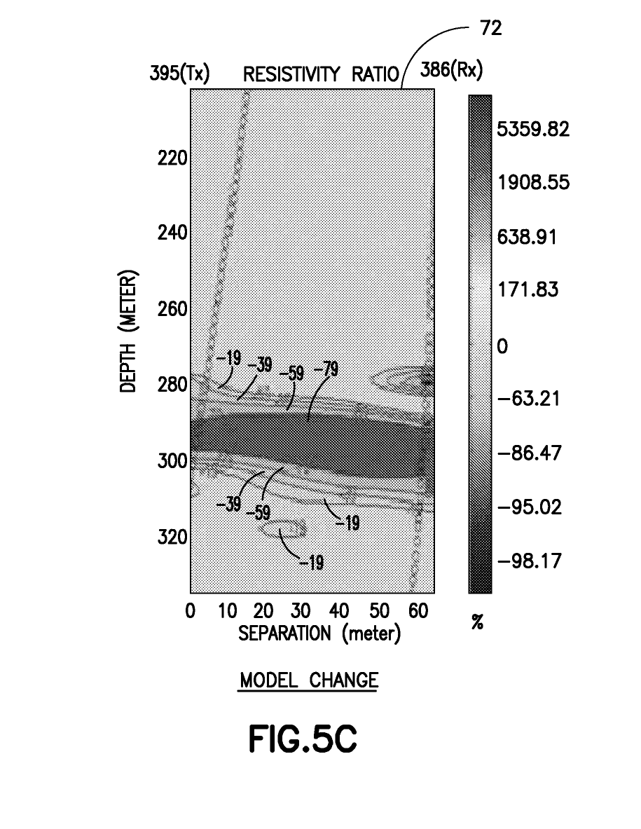

An example of a crosswell inversion is shown in FIG. 5. Here we show the Starting Model 68, the Final Model 70, and the Model Change 72 that resulted from the inversion. In this case, the target area that was intended to be imaged water injection into a particular reservoir layer. We have therefore fixed the resistivities of the upper layers during the inversion process.

We note that in addition to inverting for the interwell resistivity (or a related electromagnetic property, such as conductivity), the process can also be used to invert for borehole position. This is done using the same process described above but in this case the resistivity structure is fixed and the tool positions are allowed to vary in the inversion. In practice this usually involves inverting a lower frequency data set which is less affected by the formation resistivity than the normal tomographic data.

### Re-Importation to the Petrel Model:

After the inversion is complete and the model has been updated it can then be re-imported into Petrel. This may be accomplished by direct import of the data section and re-interpolation of the cross-section into the three dimensional cube. Alternatively, the inventive workflow may be incorporated within the software used to develop and update the background model, thereby eliminating the need to export and re-import data from the background model.

### Use of the Model in Flow Simulation and Process Control:

If the survey involves tracking a flow process such as water or steam flood, then the EM model can also be used to constrain the flow model. Flow processes are also notoriously nonunique and external constraints are hard to impose on these models due to scale differences and poor interwell knowledge. The deep EM data however offer the opportunity to accomplish this using the compatible Petrel/Eclipse model format.

Practically this process involves building a series of iterative forward models where the interwell data is used to establish geological and flow boundaries, interwell resistivity changes are used to provide reservoir saturation information and therefore pressure limits, and injection and production data are balanced with the interwell fluid changes.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative processes, one skilled in the art will recognize that the system may be embodied using a variety of specific procedures and equipment and could be performed to evaluate widely different types of applications and associated geological intervals. The inventive method could be used, for instance, to monitor the displacement of residual oil from a carbonate or siliclastic reservoir into which a fluid such as water, steam, carbon dioxide, foam, or surfactants has been injected. The method could similarly be used to monitor the recovery of oil or other types of hydrocarbons from geologic intervals such as heavy oil reservoirs, tar sands, diatomite zones, and oil shales that are undergoing primary, secondary, or tertiary recovery processes. The method can also be used to determine whether carbon dioxide or other types of greenhouse gases are appropriately sequestered after being injected into a particular subsurface area. The method could furthermore be used in mining, construction, and related applications, such as where water is injected to facilitate the production of minerals such as rock salt or sulfur or to monitor the dewatering of a rock matrix. Accordingly, the invention should not be viewed as limited except by the scope of the appended claims.

What is claimed is:

1. A method for determining whether an electromagnetic survey will be able to distinguish between different subsurface conditions in an area, comprising:
a) developing a three-dimensional electromagnetic property model of the area;
b) simulating an electromagnetic response of a field electromagnetic data acquisition system using said three-dimensional electromagnetic property model to determine if expected differences in an electromagnetic response of an electromagnetic data acquisition system are within detectability limits of said system.

2. A method in accordance with claim 1, wherein said three dimensional electromagnetic property model is developed using one or more of flow simulator results, geological data, seismic data, and log data.

3. A method in accordance with claim 2, wherein said one or more of flow simulator results, geological data, seismic data, and log data are scaled-up prior to incorporation into said three-dimensional electromagnetic property model.

4. A method in accordance with claim 1, wherein simulating said electromagnetic response of a field electromagnetic data acquisition system includes designating at least one electromagnetic source position and at least one electromagnetic receiver position, said positions being associated with a crosswell, surface-to-borehole, borehole-to-surface, or surface-based electromagnetic survey architecture.

5. A method in accordance with claim 4, wherein said positions are associated with a crosswell electromagnetic survey architecture and said three-dimensional electromagnetic property model is developed using one or more of flow simulator results, geological data, seismic data, and log data associated with a region located within at least seven times the interwell radii of the wells containing said source and receiver positions.

6. A method in accordance with claim 1, wherein said simulation of an electromagnetic response of a field electromagnetic data acquisition system includes:
i) extracting a two-dimensional section from said three-dimensional electromagnetic property model; and
ii) creating a modified two-dimensional section corresponding to a different subsurface condition.

7. A method in accordance with claim 6, wherein said modified two-dimensional section is created by changing said extracted two-dimensional section to correspond to a different subsurface condition.

8. A method in accordance with claim 6, wherein said modified two-dimensional section is created by modifying said three-dimensional electromagnetic property model to correspond to a different subsurface condition and then extracting said modified two-dimensional section from said modified three-dimensional electromagnetic property model.

9. A model-based method of inverting electromagnetic data associated with a subsurface area, comprising:
a) developing a three-dimensional electromagnetic property model of the area; and
b) restricting changes that may be made to said three-dimensional electromagnetic property model during said electromagnetic data inversion process.

10. A method in accordance with claim 9, further including extracting a two-dimensional section from said three-dimensional electromagnetic property model.

11. A method in accordance with claim 10, wherein resistivity values within a portion of said extracted two dimensional cross-section are allowed only to decrease during said electromagnetic data inversion process.

12. A method in accordance with claim 10, wherein resistivity values within a portion of said extracted two dimensional cross-section are fixed during said inversion process.

13. A method in accordance with claim 10, further including updating said three-dimensional electromagnetic property model using said changed two-dimensional section.

14. A method in accordance with claim 9, wherein said electromagnetic data is acquired at a first period of time and further including acquiring additional electromagnetic data at a second period of time and using said additional electromagnetic data to further update said three-dimensional electromagnetic property model.

15. A method in accordance with claim 14, wherein a fluid has been injected into said subsurface area between said first period of time and said second period of time.

16. A method for determining the position of a borehole within a subsurface area, comprising:
a) developing a three-dimensional electromagnetic property model of the area; and
b) allowing only borehole position to vary as electromagnetic data acquired from said subsurface area is inverted.

17. A method in accordance with claim 16, wherein said electromagnetic data comprises a low frequency electromagnetic data set that is less affected by formation resistivity than a typical tomographic electromagnetic data set.

18. A model-based method of processing electromagnetic data associated with a subsurface area, comprising:
a) developing a three-dimensional electromagnetic property model of the area;
b) extracting a two-dimensional section from said three-dimensional electromagnetic property model;
c) inverting said electromagnetic data, thereby updating said two-dimensional section; and
d) updating said three-dimensional electromagnetic property model by interpolating said updated two-dimensional section into said model.

19. A model-based method in accordance with claim 18, wherein said method further includes updating a flow simulator based on the updates made to three-dimensional electromagnetic property model.

20. A model-based method in accordance with claim 18, wherein said method further includes generating a series of iterative forward models where interwell data is used to establish geological and flow boundaries, interwell resistivity changes are used to provide reservoir saturation information, and injection and production data are balanced with interwell fluid changes.

21. A model-based method in accordance with claim 18, wherein said electromagnetic data has been acquired using inductive frequency (1 Hz-10 kHz) solenoid (magnetic dipole) electromagnetic transmitter.

22. A model-based method for designing an electromagnetic survey, comprising:
a) developing a three-dimensional electromagnetic property model of the area;
b) extracting a two-dimensional section from said three-dimensional electromagnetic property model; and
c) using said two-dimensional section during the design of the electromagnetic survey.

23. A model-based method in accordance with claim 22, wherein said design of the electromagnetic survey comprises one of more of: selecting the frequency of an electromagnetic source, determining source and receiver spacings, determining the quantity of data required, calculating quality control indicator requirements, and calculating survey duration.
